(19) United States
(12) Patent Application Publication
(10) Pub. No.: US 2013/0255218 A1
(43) Pub. Date: Oct. 3, 2013

(54) Support with Ropes and Link Module Elements

(71) Applicant: Marek Maciuba, Poznan (PL)

(72) Inventor: Marek Maciuba, Poznan (PL)

(73) Assignee: "MOA" SPÓLKA CYWILNA, Poznan (PL)

(21) Appl. No.: 13/991,532

(22) PCT Filed: Dec. 2, 2011
(86) PCT No.: PCT/PL2011/000124

§ 371 Date: Jun. 18, 2013

(30) Foreign Application Priority Data
Dec. 6, 2010 (PL) P.393158

(51) Int. Cl. F16G 15/12

(52) U.S. Cl. CPC F16G 15/12
USPC 59/84

(57) ABSTRACT

The invention relates to a modular rope link, supporting structural, mechanical, advertising and decoration elements, thanks to which they can be built and combined in sets of modules in a variety of vertical, horizontal surfaces, and different levels. Modular rope link, according to the invention, characterized in that it is a pair of vertical and/or horizontal, diagonal and preferably also diagonal ropes (1) partially or completely encircling link elements (2), which on the outer surface contain grooves (3) for the ropes encircling them (1), and each pair of ropes (1) between the link elements (2) is clamped by a connector (6).

### CROSS REFERENCE TO RELATED APPLICATION

This application is the national phase of PCT Patent Application No. PCT/PL2011/000124 filed on Dec. 2, 2011, the entire content of which is incorporated by reference herein.

### FIELD OF THE INVENTION

The invention relates to a modular rope link, supporting structural, mechanical, advertising and decoration elements, thanks to which they can be built and combined in sets of modules in a variety of vertical, horizontal surfaces, and different levels.

### BACKGROUND

Large media screens mounted on special free-standing constructions or suspended on the façades of buildings are already known. They contain a series of lamps containing light sources, which display information, lights effects, or images. In the description of the German patent application DE 10 2006 014 808 A1 a solution for information, advertisements or images display system is presented, essential element of which is a metal grid with lights on the lighting carrier. Holder for the lighting carrier is integrated with the grid, which allows removal and insertion of the lighting without disintegration of the holder, whereas the lighting carriers are arranged in a regular manner in relation to each other. In this solution, Light-Emitting Diodes are used as lamps.

The aim of the present invention is to provide a rope link construction forming a module for creating flat and spatial structures of large surfaces for various applications.

### SUMMARY

The invention relates to a modular rope link, supporting structural, mechanical, advertising and decoration elements, thanks to which they can be built and combined in sets of modules in a variety of vertical, horizontal surfaces, and different levels. Modular rope link, according to the invention, characterized in that it is a pair of vertical and/or horizontal, diagonal and preferably also diagonal ropes partially or completely encircling link elements, which on the outer surface contain grooves for the ropes encircling them, and each pair of ropes between the link elements is clamped by a connector.

### DETAILED DESCRIPTION

Modular rope link of the present invention comprises ropes connected with link elements.

The essence of the modular rope link solution lies in the fact that it is a pair of vertical and/or horizontal, and preferably, also diagonal ropes partially or completely encircling link elements which on the outer surface contain grooves for the ropes encircling them, and each pair of ropes between the link elements is clamped by a connector.

Link elements have the shape of a circular ring or constitute a ring elliptical in shape, or have the shape of a regular polygon.

The connectors are either bands made of steel strip or pipe sleeves tightened on the ropes or freely mounted on the ropes, depending on the scale adopted between link elements.

Modular rope, links can be used for a variety of applications. They can create large-surface, as well as spatial transparent façade systems for buildings, lighting façades, transparent façades, screen walls, façade shutters, balustrades, decoration walls, metal grids, openwork façades, metal curtains, carrier matrices for illumination of buildings, pergolas, patios, garden walls, shop systems, wall racks, room divider systems, shelf systems. In the holes of the link elements various elements may be installed, such as lighting in a form of lamps or fixtures for LEDs or other decorative and utilitarian details, such as shop shelves or shelves for display for exhibits displayed at exhibitions.

The object of the invention is illustrated in the drawing in which

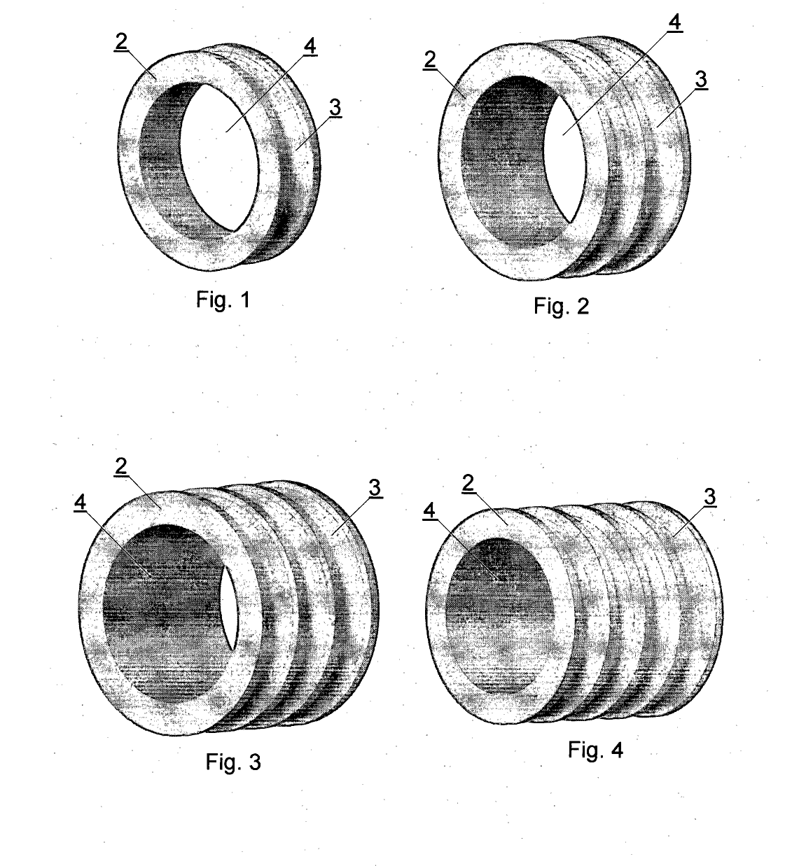

FIGS. 1, 2, 3 and 4—present views of link elements in the form of round rings with different numbers of grooves,

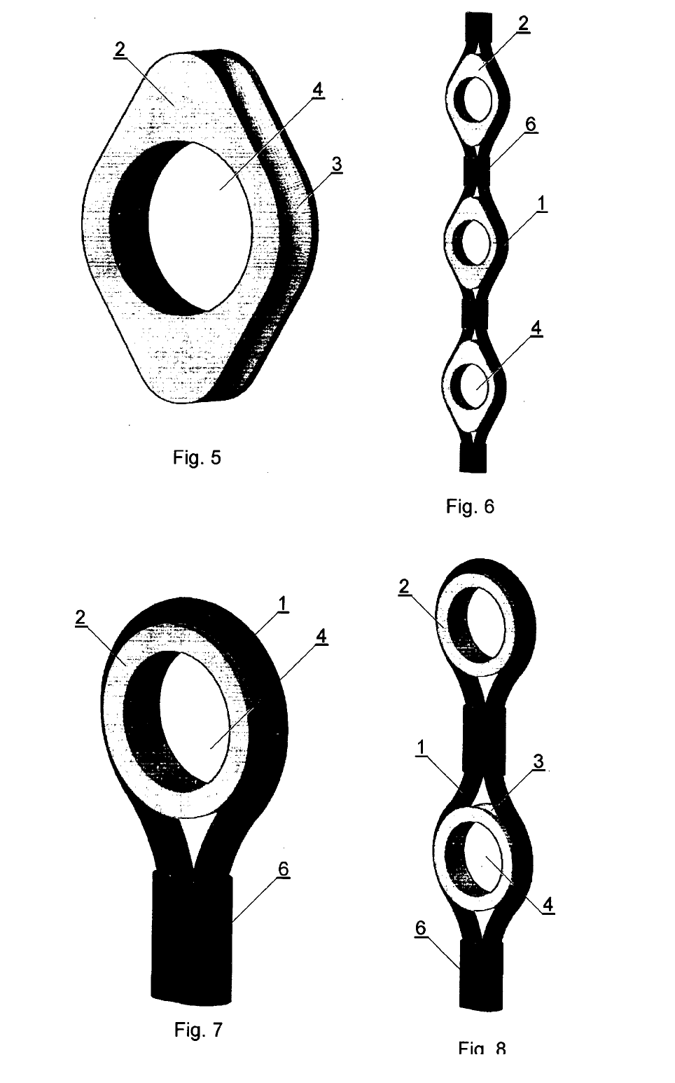

FIG. 5—a view of the link element in the form of a ring of elliptical shape,

FIG. 6—view of the chain fragment containing the link elements from FIG. 5,

FIG. 7—a view of the final part of a chain containing link element from FIG. 1,

FIG. 8—a view of the chain fragment containing the link elements from FIG. 1,

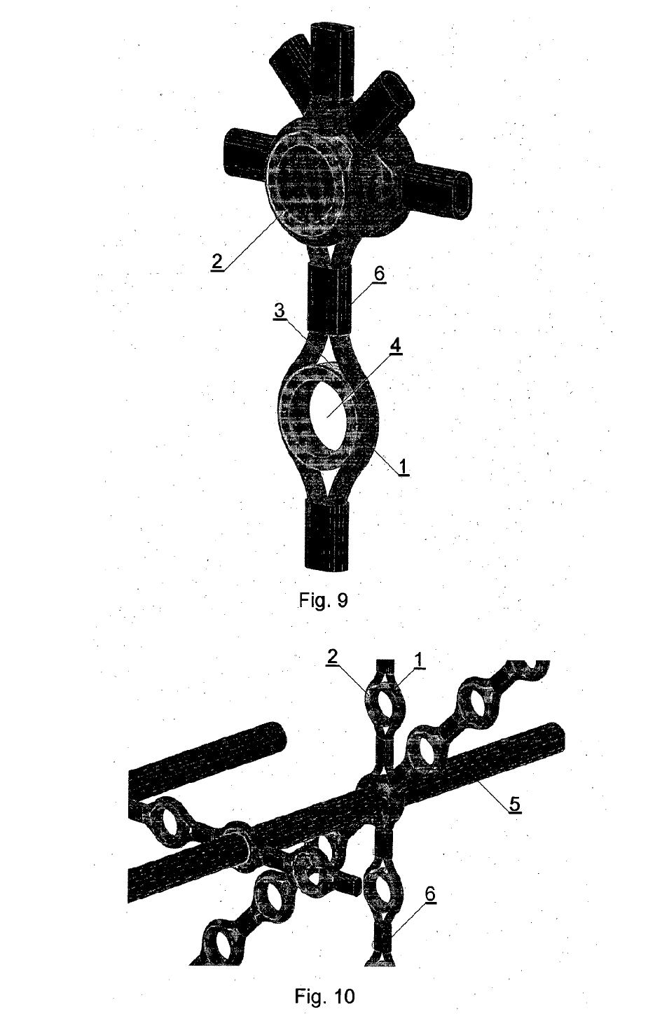

FIG. 9—a view of the node consisting of fragments of four chains containing link element from FIG. 4,

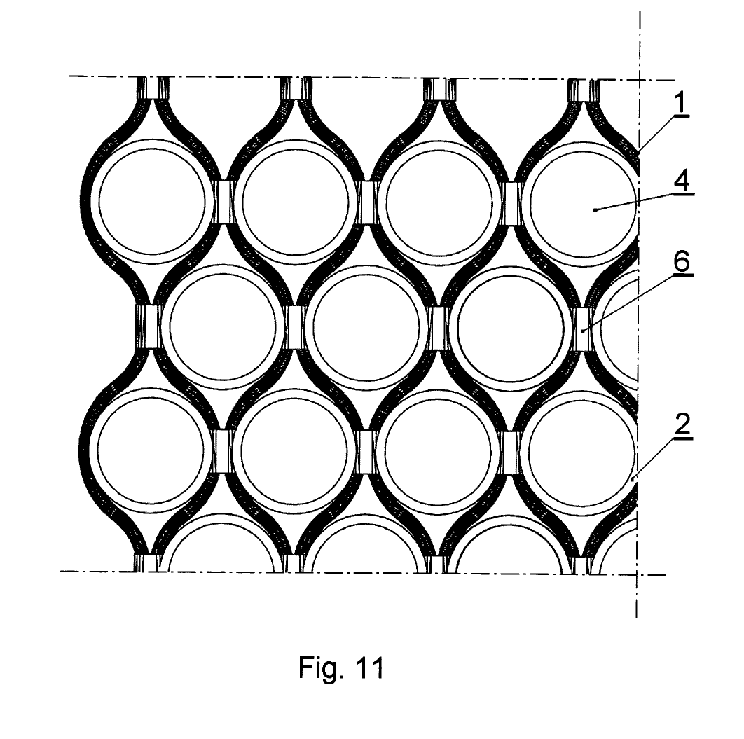

FIG. 10—a view of a part of the spatial structure consisting of two nodes connected by a rod, and

FIG. 11—a view of the plane shutter consisting of a series of ropes and link elements.

Modular rope link in the exemplary embodiment according to the invention is a pair of ropes 1 vertical, horizontal, and diagonal partially or completely encircling link elements 2. Sample ropes 1 are made of stainless steel, but ropes made of artificial fibres or natural fibres may be successfully applied. The link elements on the outer surface contain grooves 3 for acceptance of ropes encircling them 1, wherein the link element 2 can comprise 1, 2, 3, 4 or 5 grooves for a pair of ropes 1 as demonstrated in FIGS. 1, 2, 3, 4 and 5, whereas the link elements 2 contain holes 4 designed to accept different elements of different purposes possible to place in holes 4, e.g. bars 5 as shown in FIG. 10. Link elements 2 may have the shape of a circular ring or ring of elliptical shape, and may also have a regular polygon shape. Each pair of ropes 1 between the link elements 2 is clamped with connector 6, which has the form of band made of strip of metal sheet or flattened tubular sleeve. With small distances between the link elements 2 connectors 6 can be freely slid over ropes 1, while at larger distances between the link elements 2, it is advantageous if the connectors 6 are clamped by pressing on the ropes 1.

1. A modular rope link comprising ropes connected with link elements wherein the ropes comprise a pair of ropes vertical and/or horizontal, diagonal and preferably also diagonal partially or completely encircling link elements, which on the outer surface contain grooves for ropes encircling them, and each pair of ropes between the link elements is clamped by a connector.

2. The module link according to claim 1, wherein the link elements are in the shape of a circular ring.

3. The module link according to claim 1, wherein the link elements are a ring of elliptical shape.

4. The module link according to claim 1 wherein the link elements are in the shape of a regular polygon.

5. The module link according to claim 1, wherein the connectors constitute pipe sleeves clamped on the ropes.

6. The module link according to claim 1, wherein the connectors constitute pipe sleeves freely slid over the ropes.

7. The module link according to claim 1, wherein the connectors are a band made of a metal strip.
